(19) United States
(12) Patent Application Publication
(10) Pub. No.: US 2006/0224443 A1
(43) Pub. Date: Oct. 5, 2006

(54) Method, system, apparatus and computer readable medium for preparing insurance claims for retail activites

(75) Inventors: Harry Soza, San Jose, CA (US); Robert Keehan, San Francisco, CA (US); Earl P. Steinberg, Chevy Chase, MD (US); Gerald Benowitz, Las Vegas, NV (US)

Correspondence Address: ARNOLD & PORTER LLP;ATTN: IP DOCKETING DEPT., 555 TWELFTH STREET, N.W., WASHINGTON, DC, 20004-1206, US

(73) Assignee: Resolution Health, Inc.

(21) Appl. No.: 11/080,618

(22) Filed: Mar. 16, 2005

(51) Int. Cl. G06Q 30/00; G06Q 40/00

(52) U.S. Cl. 705/14; 705/4

(57) ABSTRACT

The present invention is directed to a method, apparatus and computer readable medium for reducing health care costs by creating an incentive for patients to choose the most economical, yet fully effective health care option.

### COPYRIGHT DISCLAIMER

A portion of the disclosure of this patent document contains material which is subject to copyright protection. The copyright owner of that material has no objection to the facsimile reproduction of the patent document or the patent disclosure, as it appears in the Patent and Trademark Office patent files or records, but otherwise reserves all copyright rights.

### FIELD OF THE INVENTION

The present invention relates to health care cost reduction systems. In particular, the present invention is directed to providing a) incentives to patients to utilize health care options that will reduce costs for both the patient and the sponsor of their health insurance plan or their health insurer itself and b) a practical mechanism for enabling them to act on those incentives.

### BACKGROUND OF THE INVENTION

Advances in modern-day health care have introduced many different options for the health care consumer, or patient, in nearly every aspect of health care. Typically, there is no longer just one town doctor that advises the patient on every aspect of medical care. Now there are a variety of doctors, supported by innumerable specialists—each of these with a different view on the best health care options for the patient. These different views are due in part to the multitude of medications and other types of treatment that are available. Instead of one medication for one medical problem, there are now scores of medications to treat the same problem. The same can be said for treatments other than medications. Each treatment or medication has its own benefits and drawbacks. Some of these options are therapeutically equivalent in most if not all regards, though. For example, many medications that were once only available by prescription have been released for sale without a prescription, as over-the-counter medications. Anyone can walk into a drugstore and buy them, without having a doctor prescribe them first. Many of these over-the-counter medications are identical to what was once provided by prescription only. Sometimes only the name of the medication has changed. Many of these over-the-counter medications are much more affordable to the average person than were their prescription-only counterparts or different medications that are available only by prescription. As a result, it is often much more economical to buy the over-the-counter version of the medication than the prescription version or an alternative prescription medication. Nevertheless, sales of many of these prescription drugs continue to grow. Two reasons for this continued growth in sales of the prescription version drugs are direct-to-physician marketing by pharmaceutical company sales representatives (sometimes referred to as “physician-detailing”) and direct-to-consumer marketing. Another reason for continued growth in sales of the prescription version drugs is the nature of health insurance in the United States. Just as patients have a multitude of doctors, specialists, medications and other treatments to choose from, they also have a multitude of insurance options. Most medical insurance plans include some type of prescription drug coverage. Under such plans, the patient typically pays a fixed amount (“co-pay”) for a prescription drug, and the insurance company pays the rest of the cost. Sometimes the insurance plan includes several different levels of fixed costs, such that the patient pays more for a name-brand prescription drug than for a generic prescription drug, for example. Many times the fixed cost that the patient pays for a prescription medication is lower than the retail price of the over-the-counter version or an over-the-counter alternative—which is often not covered by the insurance plan at all. As a result, although the prescription version of the medication is often vastly more expensive, sometimes approaching an order of magnitude difference, there is often an incentive for the patient to buy the more expensive prescription version or a more expensive prescription alternative, rather than an over-the-counter alternative because the prescription medication is cheaper from the patient's viewpoint. As a result, insurance companies spend millions of dollars paying for medication, when an alternative that was equally safe and effective could have been purchased for a fraction of the price. Pharmaceutical firms spend considerable sums on direct-to-consumer advertising to increase the likelihood that patients request and use the higher cost prescription options.

### SUMMARY OF THE INVENTION

The present invention is directed to a method, apparatus and computer readable medium for reducing health care costs by creating a) an incentive for patients to choose the most economical treatment option that is both safe and effective and b) a practical mechanism for enabling them to act on that incentive. According to an embodiment, a computerized analysis of a population's (e.g. health plan members, employees of a company, patients with a certain health condition) prescription drug insurance claims is performed to identify a patient that currently uses a health care option that is not the most economical, safe and effective option. A coupon is prepared for the patient, which would provide a discount for a certain health care option that provides economical benefits over the health care option currently utilized by the patient. The coupon can include identification information that can be used to track the patient's use of the coupon. In addition, the patient's prescription drug insurance claims can be monitored to see if the patient stopped using the less economical health care option. If the patient uses the coupon to purchase the more economical health care option, and stops using the less economical option formerly utilized, then additional coupons can be prepared for and sent to that patient, allowing continued use of the more economical health care option. The invention is best understood with reference to the specification, drawings, and claims.

### BRIEF DESCRIPTION OF THE DRAWINGS

FIG. 1 is a block diagram of a coupon creation and delivery system according to an embodiment of the present invention.

FIG. 2a is a block diagram of an overall system in accordance with an embodiment of the present invention.

FIG. 2b is a block diagram of an overall system in accordance with an embodiment of the present invention.

FIG. 2c is block diagram of an overall system in accordance with an embodiment of the present invention.

FIG. 3a is a representation of a coupon in accordance with an embodiment of the present invention.

FIG. 3b is a representation of a coupon in accordance with an embodiment of the present invention.

FIG. 4a is a front view of a coupon delivery system in accordance with an embodiment of the present invention.

FIG. 4b is a back view of a coupon delivery system in accordance with an embodiment of the present invention.

FIG. 5 is a view of a coupon delivery system in accordance with an embodiment of the present invention.

FIG. 6 is a block diagram in accordance with an embodiment of the present invention.

FIG. 7a is a block diagram in accordance with an embodiment of the present invention.

FIG. 7b is a block diagram in accordance with an embodiment of the present invention.

FIG. 7c is a block diagram in accordance with an embodiment of the present invention.

FIG. 7d is a block diagram in accordance with an embodiment of the present invention.

FIG. 7e is a block diagram in accordance with an embodiment of the present invention.

### DESCRIPTION OF PREFERRED EMBODIMENTS OF THE INVENTION

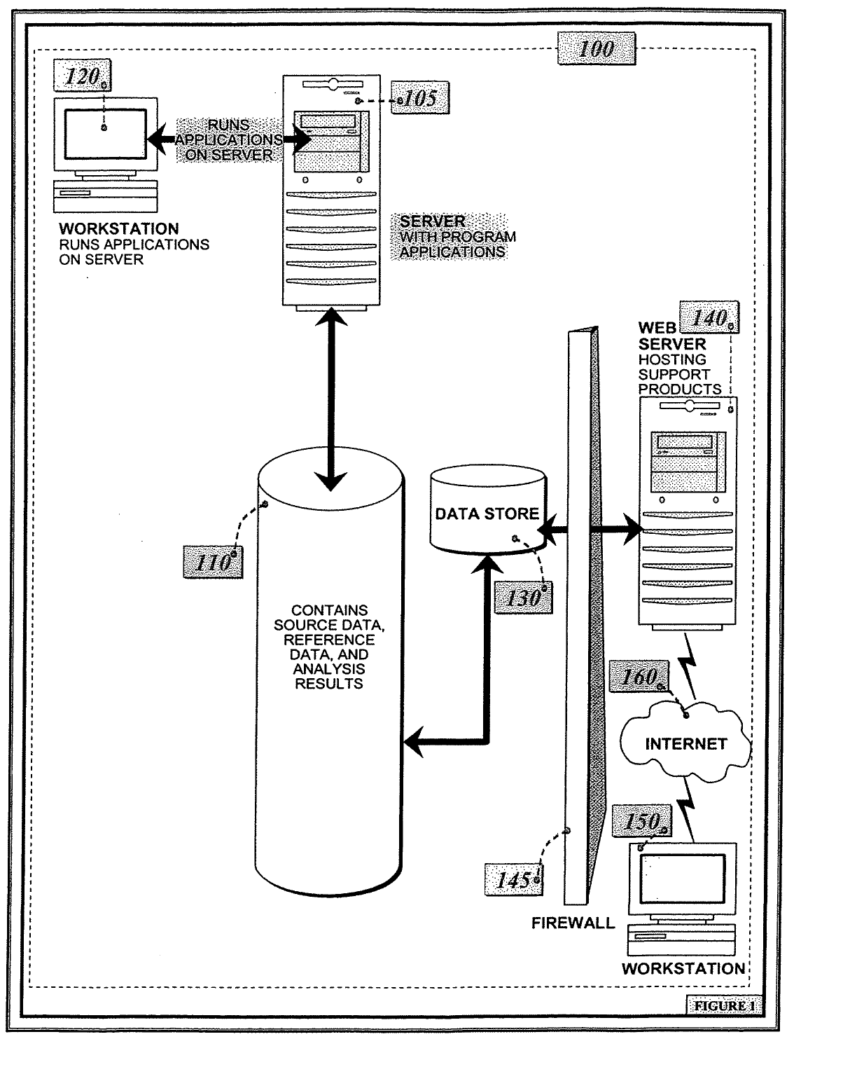

The present invention may be implemented in a computer system 100, as shown in FIG. 1. The computer system 100 includes a computer server 105 (such as MSQL 2000), which stores program applications that are employed in carrying out the present invention. One or more of these programs, which may be run by a workstation 120 (or other computer) coupled to the computer server 105, implement a rules engine (such as that described in U.S. patent application Ser. No. 10/995,090) or inference engine that permits the application of various rules to source data, such as insurance claims and medical data pertaining to patients, that is stored in a database 110 (or multiple databases), such as a relational database, that is coupled to the client server 105. By way of example, the database 110 may reside on the computer server 105 or may be on a database server (not shown) that is accessible via a network, such as a local area network, wide area network, or wireless network. Program applications may be stored on various electronic media, such as hard drives, floppy drives, or other computer readable media known in the art.

The database 110 may also store reference data that is employed in connection with the application of the rules to the source data stored therein. The database 110 may also store the analysis results, which result from the application of the rules to the source data stored therein. The reference data may include formatted and/or unformatted industry standard insurance or medical codes, or a representation thereof, which are useful in implementing the rules. The reference data may also include information describing health care providers, such as hospitals and doctors, as well as their specialties.

The computer system 100 also includes a data store 130, which may be optionally employed for large sets of source data and corresponding analysis results. The data store 130 may be coupled to the database 110 via a network. The data store 130 may be implemented as a data warehouse or data mart. If access to the database 110 or (if utilized) the data store 130 is to be provided via the Internet, then a web server 140 may be employed that includes one or more program applications that provide reports or coupons generated by embodiments of the present invention. The reports or coupons may be provided as web pages (e.g., HTML or XML based web pages), which are made accessible to a web browser residing on a workstation 150 (or other computer) that is coupled to the web server 140 via the internet 160. The reports or coupons are provided in response to user queries via the web browser. These requests may be authenticated by the web server to ensure that the person is authorized to review the information requested. Optionally, a firewall 145 may be provided between the web server 140 and the database 110 or data store 130 (if utilized).

As an alternative to the use of the web server 140, reports or coupons generated by the present invention may be provided by one or more program applications residing on the computer server 105 or workstation 150. These reports or coupons may further be printed and distributed to users manually or by some other means. Further the data file, for the coupons that have been created, can be stored in a database. When the coupon is used, it can be tracked by a redemption agent, or other entity, in a variety of ways. For example, the identification information or tracking code on the coupon can be recorded electronically to a database by the redemption agent. Alternatively, an electronic coupon could contain a tracking signal (for example a signal similar to a return receipt that can be attached to an email, which automatically notifies the sender when an email is opened) which could notify the redemption agent or other entity, for example the coupon provider, that the coupon has been redeemed electronically. These are merely examples of embodiments of this invention, and are not meant to limit the invention in any way. When usage data is received, an insurance claim can be created. This claim can be entered into the insurance claim system. This data may also be entered into the database 110, either directly, or through a report from the insurance company. In this way, the usage data can also be considered by the rules, which are implemented by a rules engine as discussed above, when they are again applied. The rules for creating coupons, which are applied by the rules engine, can therefore also consider whether a coupon has been issued or used, as well as other things, for example the health history of the user, or continued use of the more expensive health care option.

In accordance with an embodiment of the present invention, health care information is received for a plurality of patients. This patient information can be received from many different sources, as will be apparent to one having skill in the art. In accordance with an embodiment of the present invention, these sources could include records from an insurance company or program sponsor, or from individual patients through biometric data sent over a telephone line, or clinical data reported by physicians, for example. The health care information for a patient can be analyzed to determine proposed changes that may have a tendency to reduce future health care costs for individual patients and/or health plan sponsors or insurers.

These changes may include, for example, an adjustment in treatment that would reduce the overall cost of treatment. A coupon can then be issued to the patient to create an incentive for the patient to adjust his or her treatment in order to reduce the overall cost of treatment. An example of this type of treatment adjustment could be where a patient uses a prescription medication that is also available in a non-prescription form for a reduced cost. Because of insurance coverage, the patient may not have to pay the entire cost of the prescription medication, making the cost to the patient of the prescription medication less than the cost to the patient of the non-prescription, or over-the-counter, form of the medication. This can occur because often insurance coverage does not cover non-prescription, or over-the-counter medications, at least in part due to the fact that there has been no reliable and efficient way for a claim to be submitted for these products to an insurer on behalf of these patients. As a solution to this problem, a coupon can be provided to the patient which would allow the patient to receive the non-prescription form of the medication at a reduced cost relative to the cost to the patient of receiving the prescription medication, creating an incentive to the patient to use the over-the-counter medication instead of the prescription medication. Even if the insurance company pays the entire cost of this coupon, it can cost the insurance company less than if the insurance company paid only a portion of the cost of the prescription medication. According to another embodiment of the invention, the coupon could provide a discount for a preferred brand drug, i.e. a brand name prescription medication that the insurance company prefers that the patient use for some reason instead of the prescription medication the patient is currently using.

According to an embodiment of this invention, predetermined rules can be created to determine whether a coupon should be provided. These rules could include such considerations as: “does the patient use an expensive target prescription drug?” (for example, prescription proton pump inhibitors or prescription non-sedating antihistamines), “does the patient's medical history support the use of any alternative drugs?”, “does the patient's medical history indicate any reason why the patient should not be using this medication?”, “does the patient's medical history indicate any reason why the patient should not switch to a non-prescription (over-the-counter) version of the medication or a non-prescription (over-the-counter) alternative medication?”, “has the patient been issued coupons before, and, if so, has the patient used such coupons before?” All of these considerations are presented as examples of ways to determine whether to provide a coupon for a particular patient or class of patients.

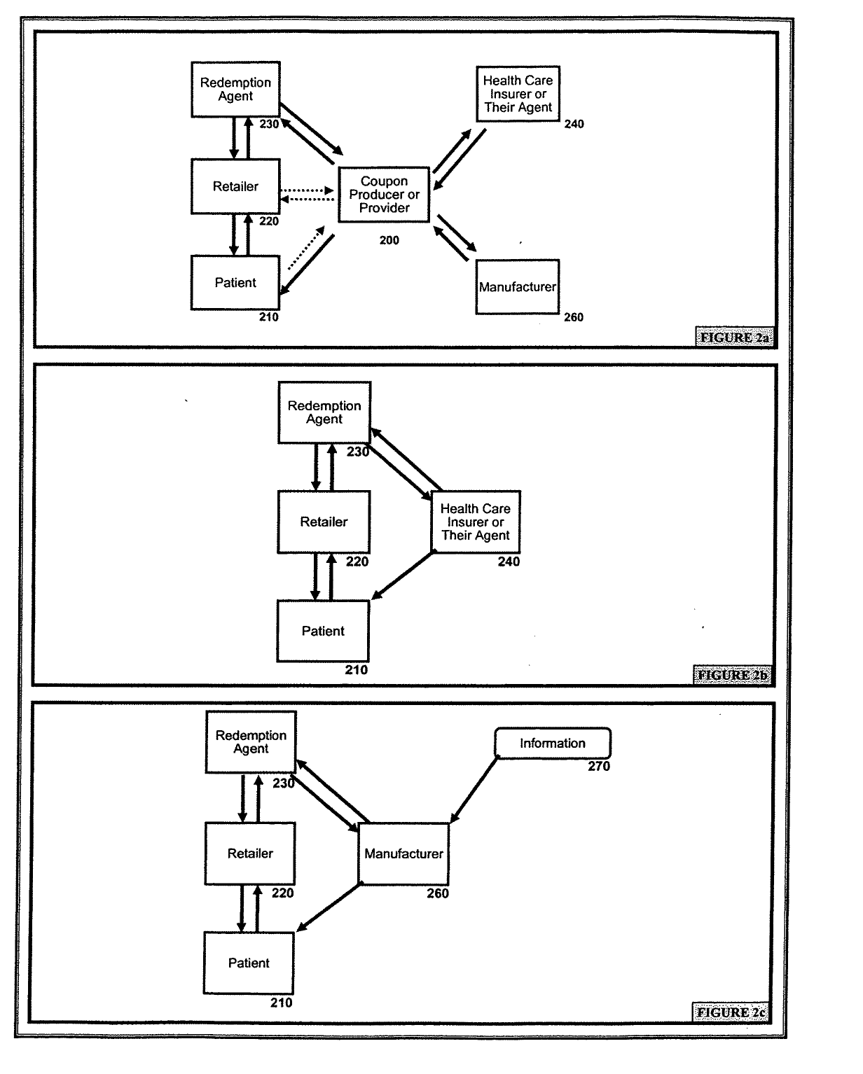

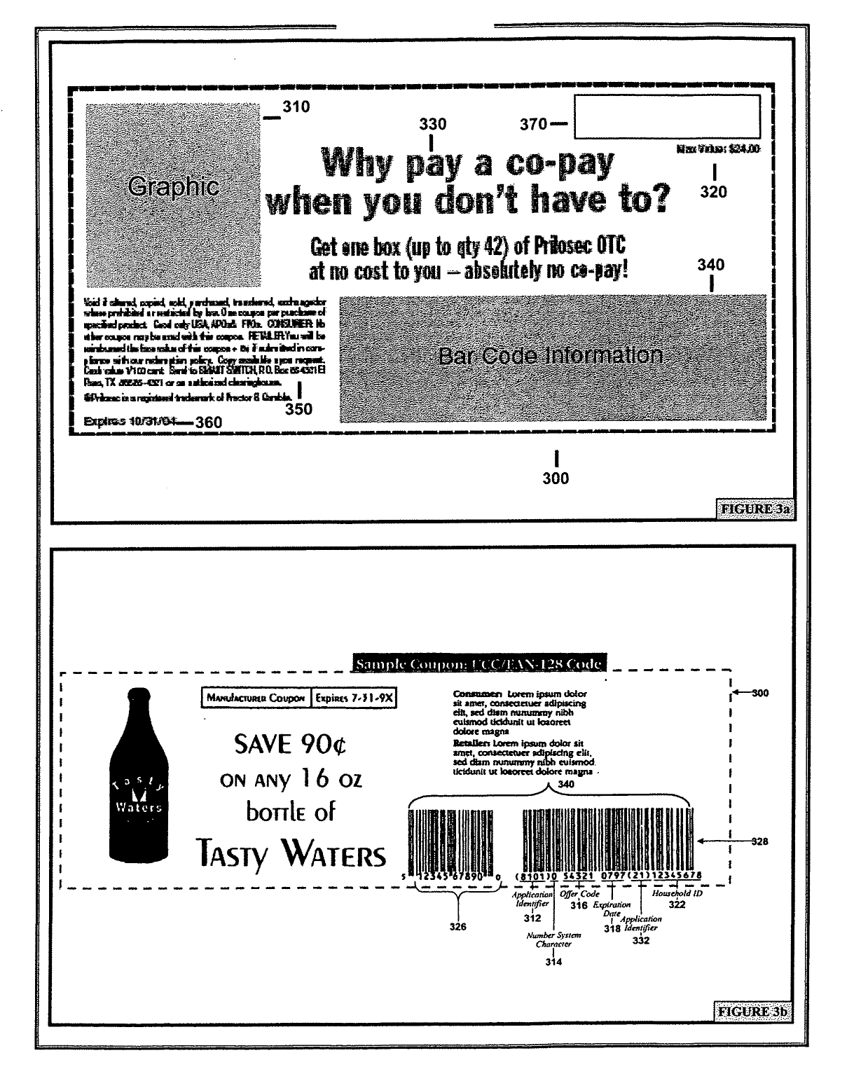

Turning to FIG. 2a, the patient can redeem the coupon in accordance with an embodiment of this invention. Coupon provider 200 provides a coupon to patient 210 to create an incentive for patient 210 to reduce overall health care costs. The coupon provider 200 can also be a producer of such coupons. According to an embodiment of this invention, this can be accomplished, for example, by the coupon provider 200 performing the steps mentioned above: determining whether a patient 210 can reduce overall health care cost by altering a form of treatment, producing a coupon that will encourage the patient 210 to switch to the alternate form of treatment, and delivering the coupon to the patient 210. Patient 210 can then redeem coupon for a discount on some health care product or service at retailer 220. Patient 210 gives retailer 220 the coupon in exchange for the discount on the product or service. The discount could be the entire price of the item. According to an embodiment of this invention, retailer 220 may further examine coupon to verify validity. Additionally, according to an embodiment of this invention, retailer 220 may analyze, record, or collect certain information that appears on the coupon. By way of example, such information could indicate one or more of the following: the expiration date of the coupon, the value of the coupon, the product or service to which the coupon applies, a tracking code, and the identity of the patient, as well as other information, as one of skill in the art will readily understand. Further, according to an embodiment of the invention, the retailer 220 could record information on the coupon, for instance, the retail price of the product or service to which the coupon applies.

The retailer 220 can then supply the information from the coupon to a redemption agent 230. According to one embodiment, the retailer 220 can supply the coupon itself (thus also supplying the information from the coupon) to the redemption agent 230. According to another embodiment, the retailer 220 can supply just the information from the coupon, and not the coupon itself to the redemption agent 230. In return, the redemption agent 230 can reimburse the retailer 220 for the value of the coupon. As will be known to one of skill in the art, the reimbursement can be for the actual value of the coupon, or can exceed the actual value of the coupon, in order to encourage retailer 220 to continue to accept coupons.

According to an embodiment of this invention, the retailer 220, could alternately provide the information from the coupon directly to the coupon provider 200, bypassing the redemption agent 230. The coupon provider 200 could then reimburse the retailer 220 directly. However, the reimbursement need not be limited to the value of the coupon.

Similarly, according to an embodiment, the patient 210 could redeem the coupon directly with the coupon provider 200, providing the coupon in exchange for the health care product or service at a discount. As a result, the retailer 220 and the redemption agent 230 need not be involved in the use of the coupon.

In instances where a redemption agent 230 is employed, the redemption agent 230 can then provide the information from the coupon to the coupon provider 200. This information can be provided in the form of the coupon itself or as compiled information such as a chart or computer database. The information could be compiled in a way that is compatible with an insurance claim system, such that an insurance company can determine whether to pay the claim as it would for any other insurance claim. The coupon provider 200 can then evaluate the information from the coupon or chart or computer database. In this way, the coupon provider 200 can determine the patient 210 whose coupon was used. This could be done, for example, by tracking which coupon was redeemed, and reviewing records to determine to whom that coupon was distributed. According to an embodiment of this invention, the coupon provider can maintain a record of all coupons in circulation. (i.e. coupons that have been produced and/or distributed, but not yet redeemed). When the coupon provider receives information showing that a particular coupon was redeemed, or that a coupon issued to a particular person was redeemed, an insurance claim can be prepared, in order to inform the insurance company of this redemption. In this way the insurance company can determine whether to pay the claim, as it would for a prescription medication, for example.

After determining what patient's 210 coupon was used, the coupon provider 200 can produce another coupon for the patient 210 in order to encourage the patient 210 to continue to reduce overall health care costs. Moreover, in accordance with an embodiment of the invention, the coupon provider or a third party can make a deposit into a health savings account for the patient in response to the patient's use of the coupon. In this way, an alternative or additional incentive could be provided for the patient to use the coupon. According to an embodiment of this invention, the coupon provider 200 can also evaluate whether the patient 210 has actually stopped using the product or service that the coupon was intended to replace, thus reducing overall health care costs. If the patient 210 used the coupon to obtain a discount on the alternative product or service, and still purchased the original product or service again, then the coupon provider 200 may choose not to produce a new coupon for the patient 210. Similarly other considerations may be evaluated by the coupon provider 200 in deciding whether to produce another coupon for the patient 210. Such considerations could include changes in the patient's health care, changes in services or products available, changes in product or service prices, changes in patient's insurance coverage, changes in availability of health care options, or changes in the patient's health, as well as others.

Further, the information from the coupons can be delivered to a health care provider 240, or to a manufacturer 260. According to an embodiment of the invention, care can be taken to ensure the privacy of the patients in this process. This can include abiding by any applicable governmental regulations of patient privacy, as well as any other measures necessary or desirable in order to ensure patient privacy. By way of example, the identification information from coupons can be delivered to the health care provider 240 or to the manufacturer 260 in summary form only, so it is not discernable what particular patients are taking part in this plan. In either case, the coupon provider 200 can be reimbursed for the value of the coupons. This reimbursement may include not only the actual value of the coupons, but may also include reimbursement for other things, which may include, for example, gathering the information from the coupons, preparing the coupons, delivering the coupons, or evaluating the health history of the patient.

As can be seen from FIG. 2b, according to an embodiment of the present invention, the health care insurer 240 can fill the role of the coupon provider 200. Thus the health care insurer 240 can determine whether a patient 210 can reduce overall health care cost by altering a form of treatment, producing a coupon that will encourage the patient 210 to switch to the alternate form of treatment, and delivering the coupon to the patient 210. Such distribution may be done through an agent or intermediary. As discussed above, the coupon, and reimbursement could then transfer between the patient 210, retailer 220, redemption agent 230, and health care insurer 240 with the health care insurer 240 filling the role of the coupon provider 200. As discussed above, according to an embodiment of the invention, the retailer 220 and the redemption agent 230 need not be involved in the processing of the coupon.

Turning to FIG. 2c, according to an embodiment of the present invention, the product manufacturer 260 can fill the role of the coupon provider 200. The product manufacturer 260 receives information 270 about the health history of the patient 210, which it can use to determine whether the patient 210 can reduce overall health care cost by altering a form of treatment. According to an embodiment of the invention, the information 270 could come from an insurance provider, doctor, pharmacy, or patient, for example, or other sources. Then the manufacturer 260 can produce a coupon that will encourage the patient 210 to switch to the alternate form of treatment, and deliver the coupon to the patient 210.

As discussed above, the coupon and reimbursement could then transfer between the patient 210, retailer 220, redemption agent 230, and manufacturer 270 with the manufacturer 270 filling the role of the coupon provider 200. As discussed above, the retailer 220 and the redemption agent 230 need not be included in the use of the coupon.

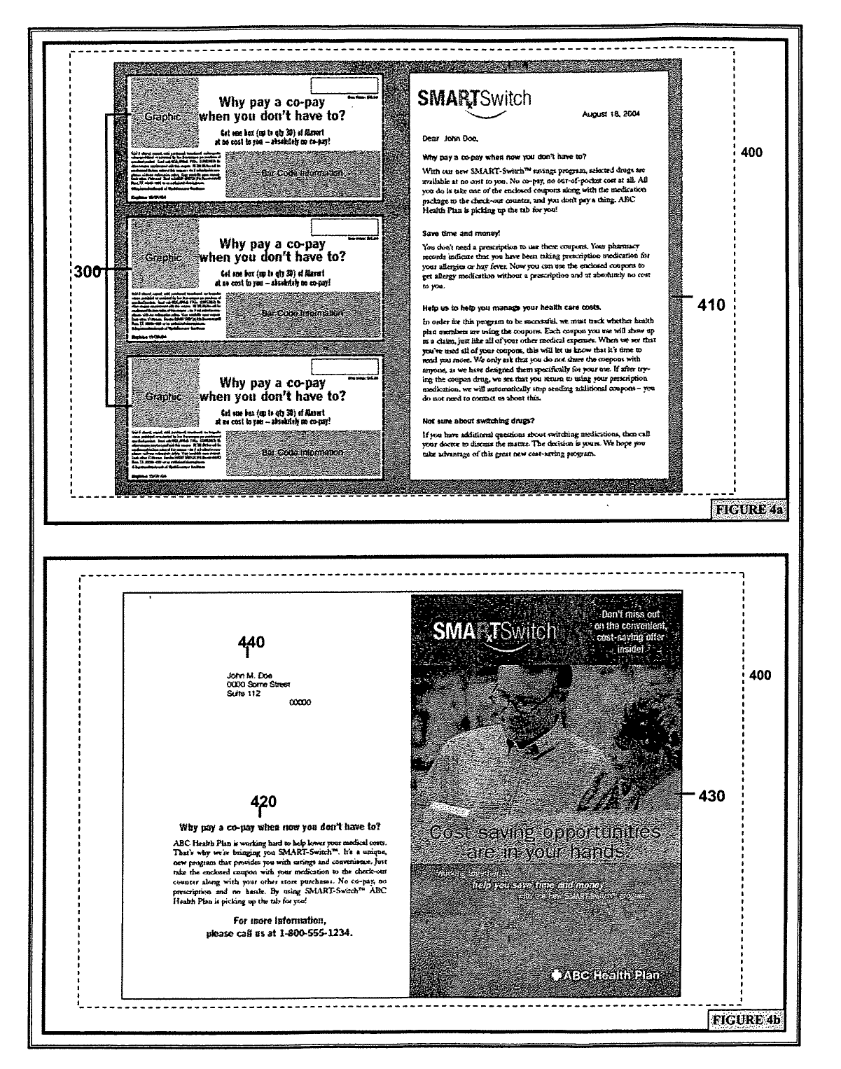

A coupon 300 according to an embodiment of this invention can be seen in FIG. 3a. As will be known by one skilled in the art, the coupon 300 can be designed with many different features. This invention is in no way limited to the features shown, but rather, features are shown to describe particular embodiments of the invention. According to an embodiment, the coupon 300, can include a graphic 310 of the product or service discounted by the coupon. The graphic 310 can be a picture of the product or service, or a symbol representing the product or service. The coupon 300 also can be prepared without the graphic 300. The coupon 300 also can, but does not need to, contain a title block 330. According to an embodiment of the invention, the title block 330 describes to the patient 210 and the retailer 220 what the coupon 300 is for, and how to use it.

For example, the title block 330 could say “Save 50 cents on your next purchase of a pharmaceutical.” In this case, the patient 210 and the retailer 220 can both understand that the coupon can be good for a fifty-cent discount on the purchase of a pharmaceutical. The coupon 300 can further include an identification information block 340. The identification information block 340 can be a bar code, a radial, two-dimensional type code symbol, or text. These examples are presented as samples of possible identification information blocks 340, and are not meant in any way to limit the present invention to a certain type of identification information block 340. The identification information block 340 can convey information such as the value and use of the coupon 300, the expiration date of the coupon 300, the identity of the patient 210 to whom the coupon was sent or who can use the coupon, as well as various other pieces of information. Again, this information is presented as description of embodiments of the invention, and should not be used to limit the invention itself to these particular disclosures. The coupon 300 can also include a text block 350, which can contain text addressed to the patient 210 or the retailer 220. The text in the text block 350 can explain, in more detail, the value of the coupon 300 and how it can be used. The coupon 300 can also include an expiration date 360. Additionally, the coupon 300 can contain a box 370, in which the retailer 220 can write the value of the coupon as redeemed. According to an embodiment of the invention, the box 370 is particularly relevant when the coupon 300 is valued as a certain percentage of the retail price of a product or service. The retailer 220 can then write in the amount that the coupon 300 was actually redeemed for. Further, the maximum value for which the coupon 300 can be redeemed can be displayed on the coupon as a max value 320. Further, as is clear to one of ordinary skill in the art, the coupon 300 could be produced in such a way that fraudulent copying will be discouraged. For example, the background of the coupon 300 could include microprinting that will blur or become more apparent when copied by a standard copying method. Similarly, according to an embodiment of the invention, the coupon 300 could be printed in color, on unusual paper, or with a color backing. As will be understood by one of ordinary skill in the art, each of these methods, along with many others, which can also be employed in accordance with the present invention, could help to reduce fraudulent copying of the coupon 300.

Turning to FIG. 3b, a coupon 300 according to an embodiment of the invention is shown. The identification information block 340 contains two bar codes. The product bar code 326 may be a Universal Product Code (UPC code) for the product or service covered by the coupon. The coupon bar code 328 may be an EAN-128 bar code. The coupon bar code 328 can include additional information arranged in a template or format in which the four digit application identifier 312 gives the format of the data to follow, a single digit number system character code 314 gives a manufacturer's number for products of the same manufacturer, a four digit offer code 316 gives a number assigned by manufacturers to code coupon offers, and a four digit expiration date 318 gives the date that the product expires, where the first two digits represent the month, and the last two digits represent the year. The coupon bar code 328 can also include a second two digit application identifier 332 followed by an identifier 322, which can be an eight digit household identifier. According to an embodiment of the invention, the identifier 322 can be unique for each coupon 300. The identifier 322 may identify the patient 210 for whom the coupon 300 was prepared by reviewing a data table that can be stored in memory, listing the patient 210 to whom each coupon 300 relates. According to another embodiment, the household identifier 322 can include a code that identifies the patient 210 for whom the coupon 300 was prepared according to a predetermined code, such as where each patient is assigned a unique number.

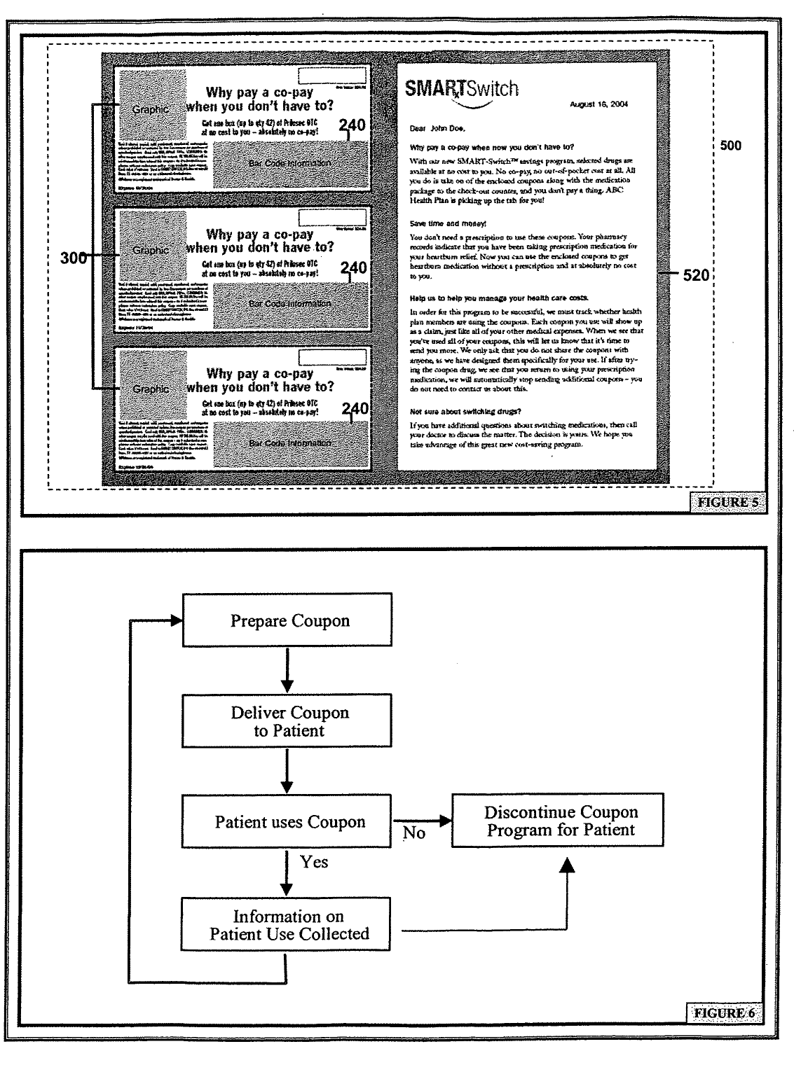

Turning now to FIG. 4a, according to an embodiment of the invention, one or more coupons 300 can be delivered to the patient 210 by the means of a mailer 400. As one of skill in the art would recognize, there are many considerations that go into the design of a mailer 420. These considerations will influence which, of many, details would be included in the mailer 400. By way of example, according to an embodiment of the invention, several coupons 300 could be included on a single sheet mailer 400. The several coupons 300 can be located on one side of the mailer as shown in FIG. 4a. As one skilled in the art would recognize, the coupons 300 could be located in the center of the page, or on the other side, or anywhere else desired. A letter 410 can also be included in the mailer 400. The letter 410 can explain the coupons 300 to the patient 210 and provide any additional information desired.

As seen in FIG. 4b, the back of the mailer 400 can also be printed according to an embodiment of the invention. An address 440 for the patient 210 can be included on the back of the mailer 400. As will be understood by one of skill in the art, the address 440 could be located in any one of many locations on the front or back of the mailer 400. According to an embodiment of the invention, the address 440 can be included on the back of the mailer 400 such that the address 440 is printed directly behind the letter 410. In this way, the coupons 300 can be cut out, and the address 440 will not be included on the back of the coupons 300. This can help to ensure privacy of the patients using and receiving the coupons. Instead, a full-color graphic 430 could be printed on the back of the coupons 300 according to an embodiment of the invention. The back of the mailer 400 can also include a text block 420 which can contain any text desired to inform the patient 210. The mailer 400 can be designed such that it can be mailed for the cost of one first-class stamp. Further, the mailer 400 can be printed on special paper, such as paper with microprinting, thermal inks, or special threads, or using special printing techniques in order to deter fraudulent copying of the coupons 300.

Turning now to FIG. 5, one or more coupons 300 can be included in an electronic mailer 500. In accordance with an embodiment of the invention, the electronic mailer 500 could be a mailer such as a mailer 400 which is electronically delivered to the user, for example via email. The user could then print out the electronic mailer 500 and use it just as the user would use the mailer 400. In accordance with another embodiment of the invention, the electronic mailer 500 could be entirely electronic, including an electronic coupon that could be redeemed electronically, for example over the internet. This electronic mailer 500 can also include a letter 520. As will be apparent to one of skill in the art, the design of the electronic mailer 500 can be the same as the mailer 400, or can differ. The electronic mailer 500 will have different considerations in its design. By way of example, the identification information block 240 can include an embedded electronic tag, or a hyperlink instead of a bar code or other visible code. The electronic mailer 500 and coupons 300 can contain additional fraud prevention measures to deter fraudulent copying of the coupons 300.

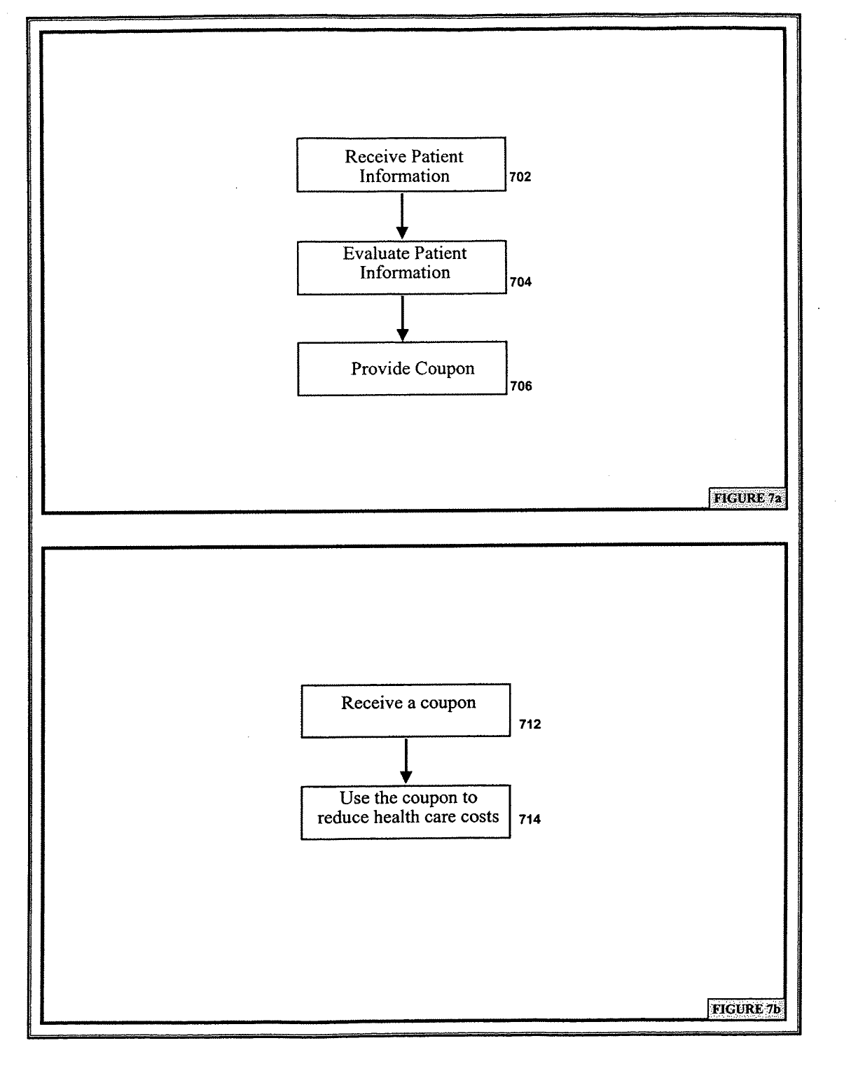

Turning now to FIG. 6, according to an embodiment of the invention, the coupon 300 is initially prepared. The coupon 300 is then delivered to the patient 210. The patient 210 can then use the coupon for a discount on a health care product or service. After the coupon 300 is used, the information on the coupon 300 eventually makes its way back to the coupon provider 200, which can be the health care insurer 240, or manufacturer 260 or other entity. The coupon provider 200 can then determine whether the patient 210 used the coupon 300. If the patient 210 used the coupon 300, then the coupon provider 200 can further verify whether the patient 210 actually switched treatments in order to reduce overall health care costs (i.e. if the patient 210 did not continue to purchase the prescription medication). If the patient 210 did use the coupon to reduce overall health care costs, instead of merely purchasing both the overall more expensive health care product or service and using the coupon 210 for a discount on the overall less expensive health care product or service as well, then the coupon provider 200 can prepare another coupon 300 for the patient 210. This example is provided merely as an example. Clearly, the invention is not limited to providing a second coupon only if the patient 210 uses the coupon but does not purchase the more expensive alternative health care product. Further, if the patient 210 did not redeem the coupon 300, then the coupon provider 200 can discontinue producing coupons 300 for that patient 210.

Additionally, the mailer 400 can be sent by itself to the patient 210, or with other informational mailings. For example, a feedback form may be included with the mailer 400. Similarly, an informational mailer may be included with the mailer 400 in order to describe the coupon program to the patient 210. A mailer summarizing the patient's health history can also be included with the mailer 400. The mailers can be selected such that all of the mailers can be mailed for the cost of one fist-class stamp.

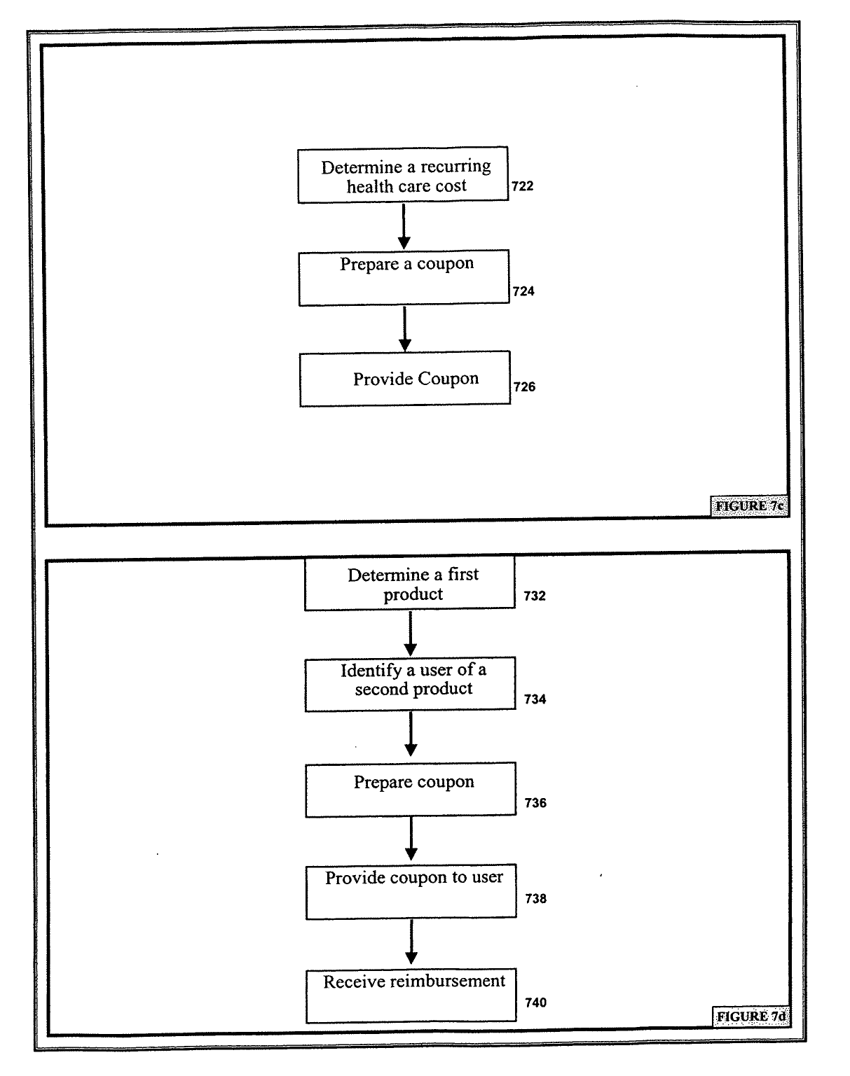

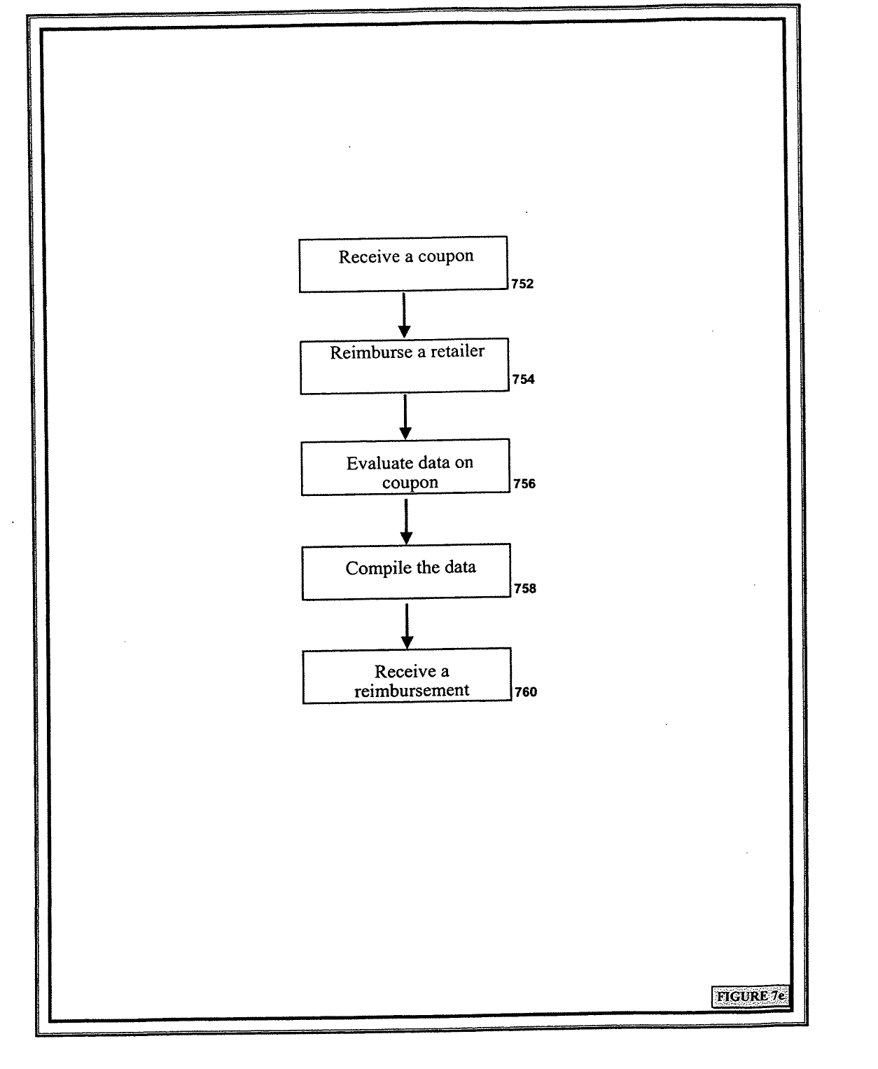

In accordance with an embodiment of the invention, as seen in FIG. 7a, one could employ a method for reducing health care costs involving receiving patient information for a patient 702, evaluating the patient information 704 to determine at least one expenditure to be replaced by at least one reduced-cost expenditure, and providing a coupon 706 to the patient to discount the reduced-cost expenditure.

Similarly, one could employ this method represented in FIG. 7a, where the expenditure is a prescription drug and the reduced-cost expenditure is medical equipment, or wherein the reduced-cost expenditure is an over-the-counter drug.

This method represented in FIG. 7a could also be employed where evaluating patient information 704 involves comparing one or more expenditures, including the expenditure already referred to as “at least one expenditure,” against a predetermined list of items, wherein the “at least one expenditure” is included in the list of items.

Moreover, this method represented in FIG. 7a could also be employed where the reduced-cost expenditure provides substantially the same benefit as the first expenditure.

This method represented in FIG. 7a could be employed with further specificity, such as: a) where the reduced-cost expenditure provides substantially the same benefits as the first expenditure, b) where the method is implemented on a computer, or c) where the coupon is an electronic coupon.

The method in FIG. 7a could also be employed, further involving: a) collecting the coupon after use, b) evaluating the patient's use of the coupon, or c) preparing a summary of usage of the coupon by the patient and cost savings related to usage of the coupon.

This method represented in FIG. 7a could also be employed, further involving tracking the use of the coupon and preparing a report of the use of the coupon. The report of the use of the coupon could be compatible with an insurance claim system, or wherein the tracking system further comprises including a tracking code on the coupon, and receiving confirmation, after the patient redeems the coupon, that the coupon with the tracking code was redeemed after the patient redeems the coupon.

According to an embodiment of the invention as seen in FIG. 7b, one could employ a method for reducing health care costs, involving receiving a first coupon 712, which is provided in response to a personal health care history and designed to reduce health care costs, and using the coupon to reduce the health care costs 714.

This method represented in FIG. 7b could also be employed, where the first coupon is an electronic coupon.

Similarly, the method represented in FIG. 7b could also be employed, where the first coupon provides a discount on the purchase of over-the-counter medication. The discount could be the full price of the over-the-counter medication. Alternatively, the first coupon could provide a discount on the purchase of medical equipment.

The method in FIG. 7b could also be employed where the coupon is provided by an insurer, including where the insurer is responsible to pay at least a portion of the health care costs. Alternatively, the first coupon could be provided by a third party on behalf of an insurer.

Moreover, the method represented in FIG. 7b could also be employed, where the first coupon contains a tracking code. This tracking code could further be used to create a report when or after the first coupon is redeemed. This report could be compatible with an insurance claim system. The tracking could also be used to decide whether the patient will receive a second coupon.

According to an embodiment of the invention as seen in FIG. 7c, one could employ a method for reducing health care costs, involving determining a recurring health care cost 722 for a patient that could be reduced through use of an alternate treatment, preparing a coupon 724 for a discount on the alternate treatment, and providing the coupon 726 to the patient.

This method represented in FIG. 7c could also be further specified, for example: a) where the coupon is an electronic coupon, b) where the alternate treatment is an over-the-counter drug, or c) where the alternate treatment is medical equipment.

This method represented in FIG. 7c could also be employed, further involving receiving information regarding the use of the coupon. This method could similarly be employed, further involving evaluating the information regarding the use of the coupon, determining that the coupon was used, preparing a second coupon for a discount on the alternative treatment, and providing the coupon to the patient.

The method in FIG. 7c could also be employed wherein providing 726 further involves providing an evaluation of health care costs paid by the patient.

This method represented in FIG. 7c could also be employed where a third party is responsible to pay at least a portion of the recurring health care cost. The third party could provide the coupon to the patient.

Moreover, the method represented in FIG. 7c could also be employed where at least a portion of the method is carried out in a computer.

This method in FIG. 7c could also be employed where the coupon contains identification information, or further involving receiving a report of the use of the coupon when or after the coupon is redeemed. This identification information could be a tracking code. The report could be compatible with an insurance claim system.

The method represented in FIG. 7c could further be employed where the coupon is processed by a redemption agent after use by the patient.

According to an embodiment of the invention as seen in FIG. 7d, one could employ a method of increasing sales by reducing costs for a third-party financer, involving determining a first product 732 that provides substantially the same benefits as a second product for a reduced cost, identifying a user of the second product 734, preparing a coupon for a discount on the first product 736, providing the coupon to the user 738, and receiving partial or complete reimbursement 740 from a third-party financer.

This method represented in FIG. 7d could also be employed where: a) the third-party financer is an insurer, b) the coupon is an electronic coupon, c) the first product is an over-the-counter medication, d) the first product is medical equipment, e) the coupon is processed by a redemption agent after use by the user.

Further, the method represented in FIG. 7d could also be employed wherein the identifying step 734 includes receiving health history information for the user from an insurer. This health history information could be just a summary, and not include identifying information for the user.

The method in FIG. 7d could also be employed, wherein the coupon includes a tracking code. The tracking code can be used to prepare a report of the redemption of the coupon after the coupon is redeemed. This report could be compatible with an insurance claim system.

According to an embodiment of the invention as seen in FIG. 7e, one could employ a method of receiving a coupon 752 from a retailer, the coupon having been provided to an end user in response to the user's health history, involving reimbursing the retailer 754 for the price of the coupon, evaluating data on the coupon 756 indicating an end user who used the coupon, compiling the data 758, and receiving a reimbursement 760 for the coupon.

This method in FIG. 7e could also be employed where: a) the data on the coupon is an identification number, b) the reimbursement includes payment for the step of evaluating the data on the coupon, c) the method is carried out on a computer, or d) the reimbursement is from an insurance claim system.

The method represented in FIG. 7e could also be employed wherein the coupon is an electronic coupon. This particular method could also be employed wherein the method is carried out on a computer.

Moreover, the method represented in FIG. 7e could also be employed wherein compiling the data 758 involves creating a report that is compatible with an insurance claim system.

We claim:

1. A coupon system for preparing insurance claims for retail activities, relating to first and second products, said first and second products providing substantially the same benefits, and said first product costing less than said second product, comprising:
a coupon that provides a discount to an end user to use said first product, said coupon being provided to said end user as a result of said end user's use of said second product so that said end user will use said first product instead of said second product, wherein a third party has a business interest in said user's switch from use of said second product to use of said first product.

2. The system of claim 1, wherein said first product is an over-the-counter alternative of said second product, which is a prescription medication.

3. The system of claim 1, wherein said third party is an insurer.

4. The system of claim 1, wherein said coupon includes an identification code.

5. The system of claim 4, further comprising a data compiler to compile data, including said identification code, on said coupon.

6. The system of claim 5, further comprising a second coupon provided in part as a result of said user using said coupon.

7. The system of claim 4, wherein said identification code is a tracking code.

8. The system of claim 1, wherein said coupon is an electronic coupon.

9. The system of claim 1, wherein said coupon is provided by a third party.

10. The system of claim 4, wherein said identification code is used to generate a report of the redemption of said coupon after said coupon is redeemed.

11. The system of claim 10, wherein said report is compatible with an insurance claim system.

12. The system of claim 1, further comprising a deposit into a health savings account in part as a result of said user using said coupon.

13. A coupon system relating to first and second products, which provide substantially the same benefits, comprising:
a coupon for a discount on said first product, which is provided to an end user based on said end user's previous purchase history relative to said second product,
a record of the redemption of said coupon,
an insurance claim for said discount linked to said end user.

14. The system of claim 13, wherein said first product is an over-the-counter alternative of said second product, which is a prescription medication.

15. The system of claim 13, wherein said first product is medical equipment.

16. The system of claim 13, wherein said coupon is an electronic coupon.

17. The system of claim 13, wherein said coupon is provided to said end user in conjunction with a report of said user's health history.

18. The system of claim 17, wherein said report further includes a review of said user's health history for cost-saving possibilities.

19. The system of claim 17, wherein said report further includes a review of said user's health history for health improvement possibilities.

20. The system of claim 13, wherein said coupon contains identification information.

21. The system of claim 20, wherein said identification information is a tracking code.

22. The system of claim 20, wherein said insurance claim is a report created from said identification information.

23. The system of claim 22, wherein said insurance claim is compatible with an insurance claim system.

24. The system of claim 20, wherein said identification information can be used by an insurance claim system to track the redemption of said coupon.

25. The system of claim 20, wherein said identification information can be used by a third party to track the redemption of said coupon in order to report the redemption to an insurance claim system.

26. A computer readable medium for preparing insurance claims for retail activities, the computer readable medium having one or more computer modules executable on one or more computer processors, the computer modules carrying out the following acts:
retrieving information about a patient from a memory,
processing said information to identify a first product that was used by said patient,
identifying a second product, where said second product provides substantially the same benefits as said first product, and where the cost of said second product is reduced relative to the cost of said first product,
preparing a coupon for said patient to induce said patient to purchase said second product instead of said first product,
determining whether said patient used said coupon.

27. The medium of claim 26, wherein said coupon is an electronic coupon.

28. The medium of claim 26, further comprising evaluating said patient's health history.

29. The medium of claim 28, wherein said patient's health history is included in said information about said patient in memory.

30. The medium of claim 28, further comprising preparing a report of said patient's health history, and wherein the act of providing further includes preparing a report of said patient's health history to said patient.

31. The medium of claim 26, further comprising:
preparing a second coupon for said patient to induce said patient to purchase said first product instead of said second product, where said second coupon is prepared at least in part because said patient used said coupon, and
providing said second coupon to said patient.

32. The medium of claim 26, further comprising:
depositing funds into a health savings account for said patient at least in part because said patient used said coupon.

33. The medium of claim 26, wherein said first product is an over-the-counter medication.

34. The medium of claim 26, wherein said first product is a preferred brand drug.

35. The medium of claim 26, wherein said first product is a generic drug.

36. The medium of claim 26, wherein said first product is medical equipment.

37. The medium of claim 26, further comprising receiving data of said patient's health history from a doctor or pharmacy or the patient.

38. The medium of claim 26, wherein said coupon includes information identifying said patient.

39. the medium of claim 26, wherein information regarding the use of said coupon by said patient is added to said information about said patient in memory.

40. The medium of claim 26, wherein said coupon is a tangible coupon which will be manually delivered to said patient.

41. The medium of claim 26, wherein said coupon includes identification information.

42. The medium of claim 41, wherein said identification information is a tracking code.

43. The medium of claim 41, further carrying out the following acts:
receiving information regarding the redemption of said coupon based on said identification information, and
preparing a report on said redemption of said coupon.

44. The medium of claim 43, wherein said report is compatible with an insurance claim system.

45. An apparatus for preparing insurance claims for retail activities, the apparatus comprising:
one or more computer processors that
receive patient information for a first patient,
store said patient information in memory,
evaluate said patient information for the first patient to identify payment for a first product, where said first product has substantially the same effects as a second product, and where the cost of said second product is reduced relative to the cost of said first product, and
prepare a coupon for the first patient, said coupon providing a discount for said second product.

46. The apparatus of claim 45, wherein said one or more computer processors further receive data regarding the use of said coupon.

47. The apparatus of claim 46, wherein said one or more computer processors further evaluate said data, and prepare a second coupon for said first patient, said coupon providing a discount on said first product.

48. The apparatus of claim 47, wherein said one or more computer processors prepare said second coupon because said first patient used said coupon.

49. The apparatus of claim 48, wherein said first patient used said coupon instead of paying for said second product.

50. The apparatus of claim 46, wherein said one or more computer processors further evaluate said data, and deposit funds into a health savings account for said first patient.

51. The apparatus of claim 50, wherein said one or more computer processors deposit said funds because said first patient used said coupon.

52. The apparatus of claim 51, wherein said first patient used said coupon instead of paying for said second product.

53. The apparatus of claim 45, wherein said coupon is an electronic coupon.

54. The apparatus of claim 45, wherein said coupon is a physical coupon.

55. The apparatus of claim 45, wherein said payment for said first product by said first patient did not comprise the full cost of said first product.

56. The apparatus of claim 55, wherein said discount is such that the end cost of said second product after said discount is reduced relative to the portion of said full cost of said first product that was paid by said first patient.

57. The apparatus of claim 45, wherein said coupon contains identification information.

58. The apparatus of claim 57, wherein said identification information is a tracking code.

59. The apparatus of claim 57, wherein said identification information is used to create a report on the redemption of said coupon after said coupon is redeemed.

60. The apparatus of claim 59, wherein said report is compatible with an insurance claim system.

61. a computer readable medium for preparing insurance claims for retail activities, the computer readable medium having one or more computer modules executable on one or more computer processors, the computer modules carrying out the following acts:
receiving information about a coupon, said coupon being prepared specifically for a patient, at least in part as a result of a first health care purchase by said patient, where a second health care purchase provides substantially the same benefits as said first health care purchase, and where the cost of said second health care purchase is reduced relative to the cost of said first health care purchase, and
redeeming said coupon for a discount on said second health care purchase.

62. The medium of claim 61, wherein said coupon is an electronic coupon.

63. The medium of claim 61, wherein said act of redeeming further includes transferring identification information included as part of said coupon.

64. The medium of claim 63, wherein said identification information is a tracking code.

65. The medium of claim 63, wherein said identification information is compiled so that it is compatible with an insurance claim system.

66. The medium of claim 61, wherein said patient only paid a portion of the full cost of said first health care purchase.

67. The medium of claim 66, wherein said discount on said second health care purchase is such that the ultimate cost to said patient for said second health care purchase is reduced relative to said portion of said full cost of said first health care purchase paid by said patient.

68. The medium of claim 61, wherein said second health care purchase is over-the counter medication.

69. The medium of claim 61, wherein said second health care purchase is a preferred brand drug.

70. The medium of claim 61, wherein said second health care purchase is a generic drug.

71. The medium of claim 61, wherein said second health care purchase is medical equipment.

72. a computer readable medium for preparing insurance claims for retail activities, the computer readable medium having one or more computer modules executable on one or more computer processors, the computer modules carrying out the following acts:
receiving information about health care expenses that a patient has incurred,
storing said information in memory,
evaluating said information to determine a recurring health care expense that could be beneficially replaced by an alternate treatment, and
preparing a coupon for said patient for a discount on said alternate treatment.

73. The medium of claim 72, wherein said coupon is an electronic coupon.

74. The medium of claim 72, further comprising evaluating said patient's health care expenses.

75. The medium of claim 74, further comprising preparing a report of said patient's health care expenses, and wherein the providing step further includes providing a copy of said report of said patient's health care expenses to said patient.

76. The medium of claim 72, wherein said first product is an over-the-counter medication.

77. The medium of claim 72, wherein said first product is a preferred brand drug.

78. The medium of claim 72, wherein said first product is a generic drug.

79. The medium of claim 72, wherein said first product is medical equipment.

80. The medium of claim 72, wherein said health care expenses are at least in part paid by an insurer.

81. The medium of claim 72, wherein the computer modules further receive data regarding the use of said coupon.

82. The medium of claim 81, wherein the computer modules further prepare a second coupon in response to said patient using said coupon.

83. The medium of claim 81, wherein the computer modules further deposit funds into a health savings account for said patient in response to said patient using said coupon.

84. The medium of claim 72, wherein said coupon includes identifying information.

85. The medium of claim 84, wherein said identifying information is a tracking code.

86. The medium of claim 84, wherein said identifying information is used to create a report after said coupon is redeemed.

87. The medium of claim 86, wherein said report is compatible with an insurance claim system.

88. a computer readable medium for increasing sales, the computer readable medium having one or more computer modules executable on one or more computer processors, the computer modules carrying out the following acts:
identifying a user of a first product, where said first product provides substantially the same benefits as a second product, and where the cost of said second product is reduced relative to the cost of said first product,
preparing a coupon for said user to induce said user to purchase said second product instead of said first product,
providing said coupon to said user, and
receiving reimbursement for said coupon from a third-party financer.

89. The medium of claim 88, wherein said coupon is an electronic coupon.

90. The medium of claim 88, wherein said third-party financer is an insurer.

91. The medium of claim 88, wherein said first product is an over-the-counter medication.

92. The medium of claim 88, wherein said first product is a preferred brand drug.

93. The medium of claim 85, wherein said first product is a generic drug.

94. The medium of claim 88, wherein said first product is medical equipment.

95. The medium of claim 88, further comprising receiving data of said patient's health history from a doctor or pharmacy or the patient.

96. The medium of claim 95, wherein said data of said patient's health history is a summary, without identifying said patient.

97. The medium of claim 88, wherein said coupon includes identifying information.

98. The medium of claim 97, wherein said identifying information is a tracking code.

99. The medium of claim 97, wherein said identifying information is used to create a report of redemption of said coupon after said coupon is redeemed.

100. The medium of claim 99, wherein said report is compatible with an insurance claim system.

101. The medium of claim 100, wherein an insurance claims system can use said report to determine whether said user purchased said second product instead of said first product.

102. The medium of claim 99, further carrying out the act of:
depositing funds into a health savings account for said patient in response to use of said coupon for said patient.

103. a computer readable medium for preparing insurance claims for retail activities, the computer readable medium having one or more computer modules executable on one or more computer processors, the computer modules carrying out the following acts:
receiving information about a coupon from a retailer, said coupon prepared for an end user based on a health history for said end user,
reimbursing said retailer for the face value of said coupon,
evaluating data on said coupon indicating said end user who used said coupon,
compiling said data in memory,
creating a report of redemption of said coupon after said coupon is redeemed, said report being compatible with an insurance claim system, and
getting reimbursement for said coupon.

104. The medium of claim 103, wherein said coupon is an electronic coupon.

105. The medium of claim 103, wherein said data on said coupon is an identification number.

106. The medium of claim 103, wherein said data on said coupon is a tracking code.

107. The medium of claim 103, wherein said reimbursement includes payment for said act of evaluating said data on said coupon.
